(19) United States
(12) Patent Application Publication
(10) Pub. No.: US 2010/0293186 A1
(43) Pub. Date: Nov. 18, 2010

(54) SEARCH DEVICE, SEARCH METHOD, SEARCH PROGRAM, AND COMPUTER READABLE RECORDING MEDIUM

(75) Inventors: Ippei Nambata, Fujimi-shi (JP); Yuuki Kusumoto, Kawashima-town (JP); Takeshi Kodaka, Nakano-ku (JP); Takao Chiba, Nerima-ku (JP)

Correspondence Address: YOUNG & THOMPSON, 209 Madison Street, Suite 500, Alexandria, VA, 22314, US

(73) Assignee: Pioneer Corporation, Tokyo (JP)

(21) Appl. No.: 12/521,650

(22) PCT Filed: Dec. 27, 2006
(86) PCT No.: PCT/JP2006/326124

§ 371 Date: Jul. 2, 2009

(51) Int. Cl. G06F 17/30

(52) U.S. Cl. 707/769; 707/E17.014

(57) ABSTRACT

A search apparatus includes an input unit that receives an input of search-object information indicative of facilities to be searched for; a designating unit that designates, among combinations of facilities indicated by the search-object information, a combination of the facilities that are located on the same premises; a generating unit that, using location information concerning the facilities constituting the combination designated by the designating unit, generates search result information; and an output unit that outputs the search result information generated by the generating unit.

### TECHNICAL FIELD

The present invention relates to a search apparatus, a search method, a search program, and a computer-readable recording medium that search for facilities. Application of the present invention, however, is not limited to the search apparatus, the search method, the search program, and the computer-readable recording medium as described above.

### BACKGROUND ART

Conventionally, a car navigation apparatus that guides a vehicle to a destination, searches for an optimal route to a destination that has been set, and guides the vehicle to the destination by guiding the driver by a means such as map display and audio guidance concerning the retrieved route (see, for example, Patent Document 1 described below).

Patent Document 1: Japanese Laid-Open Patent Application Publication No, H6-309595

### DISCLOSURE OF INVENTION

### Problem to be Solved by the Invention

However, the above-described conventional technology has a configuration in which facilities are searched for one by one when a route is set passing plural facilities. Specifically, for example, when a route is set passing a restaurant and a gas station sequentially, the restaurant is searched for and set as a waypoint, and subsequently, the gas station is searched for and set as the next waypoint according to the order of waypoints. Thus, when a route is set by way of plural facilities, one example of a problem is that it is troublesome to set the points and the operation becomes cumbersome.

### Means for Solving Problem

To solve the problems above and achieve an object, a search apparatus according to the invention of claim 1 includes an input unit for receiving an input of search-object information about a plurality of facilities to be searched; an extracting unit for extracting, based on the search-object information input by the input unit, location information about the plurality of facilities from map information depicting an arbitrary search area on a map; a calculating unit for using the location information extracted by the extracting unit to calculate an inter-facility distance in a combination including at least two or more facilities among the plurality of facilities; a designating unit for designating, based on the inter-facility distance calculated by the calculating unit, a combination including two or more facilities, which becomes a search result based on the search-object information; a generating unit for using the location information about the two or more facilities in the combination designated by the designating unit to generate search result information; and an output unit for outputting the search result information generated by the generating unit.

A search apparatus method according to the invention of claim 13 includes an input step of receiving an input of search-object information about a plurality of facilities to be searched; an extracting step of extracting, based on the search-object information input at the input step, location information about the plurality of facilities from map information depicting an arbitrary search area on a map; a calculating step of using the location information extracted at the extracting step to calculate an inter-facility distance in a combination including at least two or more facilities among the plurality of facilities; a designating step of designating, based on the inter-facility distance calculated at the calculating step, a combination including two or more facilities, which becomes a search result based on the search-object information; a generating step of using the location information about the two or more facilities in the combination designated at the designating step to generate search result information; and an output step of outputting the search result information generated at the generating step.

A search program according to the invention of claim 14 causes a computer to execute to the search method according to claim 13.

A computer-readable recording medium according to the invention of claim 15 stores therein the search program according to claim 14.

### BRIEF DESCRIPTION OF DRAWINGS

FIG. 1 is a block diagram of an exemplary functional configuration of a search apparatus according to an embodiment;

FIG. 2 is a flowchart of processing by the search apparatus according to the present embodiment;

FIG. 3 is a block diagram of a hardware configuration of the navigation apparatus according to a first example;

FIG. 4 is a diagram of one example of a search condition designation screen in the navigation apparatus of the first example;

FIG. 5 is a diagram of one example of a display screen displaying a search result of the navigation apparatus according to the first example;

FIG. 6 is a diagram (part one) of one example of a search result for combination of A bookstore and B coffee shop according to the first example;

FIG. 7 is a diagram (part two) of one example of a search result for combination of the A bookstore and the B coffee shop according to the first example;

FIG. 8 is a diagram (part three) of one example of a search result for combination of the A bookstore and the B coffee shop according to the first example;

FIG. 9 is a flowchart of processing by the navigation apparatus according to the first example;

FIG. 10 is a diagram of one example of a display screen of a search result for the A bookstore, according to the navigation apparatus of a second example;

FIG. 11 is a diagram of one example of a display screen of a search result for the B coffee shop, according to the navigation apparatus of the second example;

FIG. 12 is a diagram of one example of a display screen of a search result for a combination of the A bookstore and the B coffee shop, according to the navigation apparatus of the second example;

FIG. 13 is a diagram of one example of premises data indicative of information concerning shops on the same premises, according to the third example;

FIG. 14 is a diagram of one example of a display screen of a search result according to the navigation apparatus of the third example;

FIG. 15 is a diagram of one example of a selection of waypoints, according to the navigation apparatus of a fourth example;

FIG. 16 is a diagram of one example of a setting of a destination, according to the navigation apparatus of the fourth example;

FIG. 17 is a diagram (part one) of one example of the setting of the destination using a point of a parking lot, according to the navigation apparatus of the fourth example;

FIG. 18 is a diagram (part two) of one example of the setting of the destination using the point of the parking lot according to the navigation apparatus of the fourth example;

FIG. 19 is a diagram of one example of shops subject to a search according to the navigation apparatus of the fourth example and parking lot data of parking lots affiliated with the shops;

FIG. 20 is a diagram of one example of shop guidance according to the navigation apparatus of the fourth example; and

FIG. 21 is a flowchart of processing by the navigation apparatus according to the fourth example.

### EXPLANATIONS OF LETTERS OR NUMERALS

100 search apparatus
101 input unit
102 extracting unit
103 calculating unit
104 designating unit
105 generating unit
106 output unit
107 determining unit

### BEST MODE(S) FOR CARRYING OUT THE INVENTION

Exemplary embodiments of the search apparatus, the search method, the search program, and the computer-readable recording medium according to the present invention will be described in detail with reference to the attached figures.

### Embodiment

### Functional Configuration of Search Apparatus

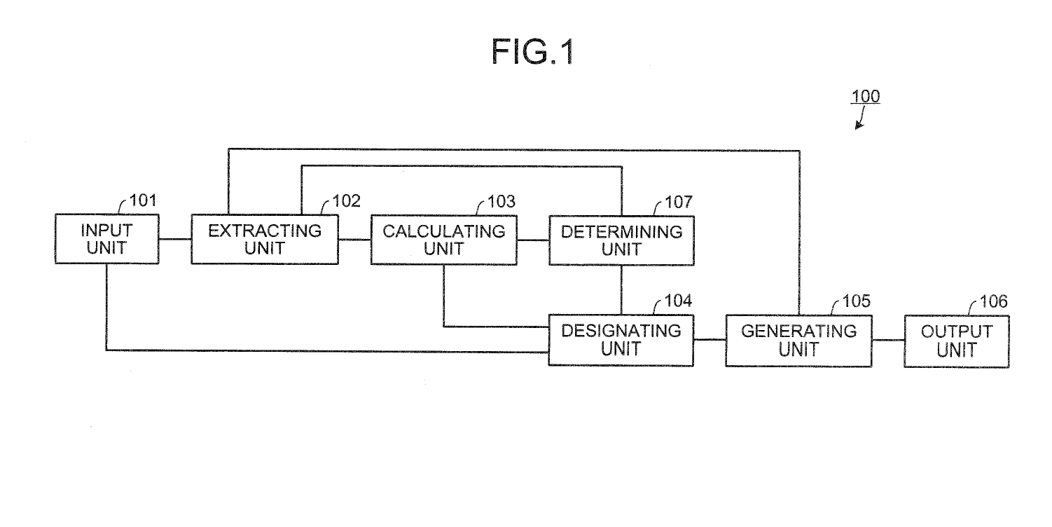

A functional configuration of the search apparatus according to the present embodiment will be described with reference to FIG. 1, FIG. 1 is a block diagram of an exemplary functional configuration of the search apparatus according to the present embodiment.

As depicted in FIG. 1, a search apparatus 100 includes an input unit 101, an extracting unit 102, a calculating unit 103, a designating unit 104, a generating unit 105, an output unit 106, and a determining unit 107.

The input unit 101 receives an input of search-object information concerning plural facilities to be searched for. Alternatively, for example, the search-object information may be input through an operation performed by the user with respect to an operation unit, not depicted. The search-object information is information such as the names and genres of facilities to be searched for.

Specifically, for example, the input unit 101 may receive an input of genres of multiple facilities as the search-object information. Further, for example, the input unit 101 may receive an input of multiple facility names as the search-object information.

The input unit 101 may receive an input designating a combination of two or more facilities, based on a determination result of the determining unit 107 described hereinafter.

The extracting unit 102, based on the search-object information input to the input unit 101, extracts from map information depicting an arbitrary search area on a map, location information concerning the facilities. For example, the location information is recorded on a recording medium, not depicted, and is detailed information about a given location, namely, information including attribute information such as position information and facility names, entrance and exit information for facilities, and parking lot information.

In addition, after the extracting unit 102 extracts the location information for arbitrary facilities among plural facilities, the extracting unit 102 may extract location information for facilities other than the arbitrary facilities, facilities nearest to each of the arbitrary facilities. That is, even if there is abundant location information for each of the facilities, the volume of location information for the other facilities is less than the volume of location information for the arbitrary facilities, and thus, the processing load of the extracting unit 102 can be reduced.

The calculating unit 103, using the location information extracted by the extracting unit 102, calculates an inter-facility distance for a combination of at least two facilities among the facilities. Specifically, for example, the calculating unit 103 calculates the distance between two or more facilities, using the location information for each of the facilities.

The designating unit 104 designates, based on inter-facility distances calculated by the calculating unit 103, a combination of facilities as a search result based on the search-object information. Specifically, for example, the designating unit 104 may designate a combination of facilities between which the inter-facility distance is equal to or less than a predetermined distance.

The designating unit 104 may designate a combination of two or more facilities, based on a determination result obtained by the determining unit 107 described later. Specifically, for example, a combination of two or more facilities determined to be on the same premises by the determining unit 107 may be designated as the search result based on the search-object information. The designating unit 104 may designate a combination of two or more facilities according to the specified combination of two or more facilities input to the input unit 101.

The generating unit 105 generates search result information, using the location information for the two or more facilities included in the combination designated by the designating unit 104. For example, the search result information may include information concerning the facilities constituting the designated combination.

Specifically, for example, the generating unit 105 may generate, using the location information for the two or more facilities in the combination designated by the designating unit 104, route information for a route passing the facilities.

More specifically, for example, the generating unit 105 may generate route information to a parking lot that can be used for two or more facilities. The generating unit 105 may generate route information to a parking lot when there is the parking lot located within a predetermined distance from two or more facilities.

The output unit 106 outputs the search result information generated by the generating unit 105. Specifically, for example, the output unit 106 outputs the search result information to a display unit and an audio output unit, not depicted, to notify the user of the search result.

When the inter-facility distance calculated by the calculating unit 103 is equal to or less than the predetermined distance, the determining unit 107 refers to the location information for the concerned facilities, and determines whether the facilities are on the same premises. Specifically, for example, the determining unit 107 may determine whether the facilities are in the same building or complex.

The determining unit 107 may determine whether two or more facilities are on the same premises according to the shape of display data depicting the facilities.

### (Details of Processing by Search Apparatus)

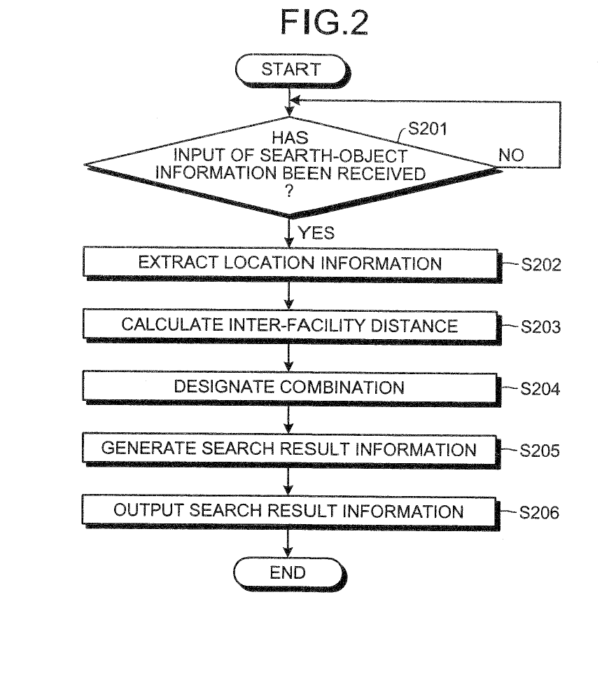

Next, details of the processing by the search apparatus 100 according to the present embodiment will be described. FIG. 2 is a flowchart of the processing by the search apparatus according to the present embodiment. As depicted in the flowchart of FIG. 2, first, it is determined whether the input unit 101 has received an input of search-object information concerning plural facilities to be searched for (step S201).

Waiting occurs at step S201. When the input unit 101 has received the input of search-object information at step S201 (step S201: YES), the extracting unit 102, based on the search-object information input at step S201, extracts location information for the facilities from map information depicting an arbitrary search area on a map (step S202).

Next, the calculating unit 103, using the location information extracted at step S202, calculates the inter-facility distance for a combination of two or more facilities among the plural facilities (step S203).

Then, the designating unit 104, based on inter-facility distances calculated at step S203, designates a combination of two or more facilities as a search result based on the search-object information (step S204). Although explanation is omitted in the flowchart of FIG. 2, designation of the combination may be made, for example, by designating a combination of two or more facilities based on a determination result of the determining unit 107.

Next, the generating unit 105, using the location information for the facilities in the combination designated at step S204, generates search result information (step S205). For example, the search result information includes information concerning the facilities constituting the designated combination, and may be route information for a route passing the facilities in the combination.

Subsequently, the output unit 106 outputs the search result information generated at step S205 (step S206), thereby ending a series of the processing. For example, the search result information may be output to the display unit and the audio output unit, not depicted, thereby notifying the user of the search result.

Although the search apparatus, the search method, the search program, and the computer-readable recording medium according to the present invention realize respective functions via the search apparatus 100 depicted in FIG. 1, the invention is not limited to the search apparatus 100, and the search apparatus 100 may include plural apparatuses provided the apparatuses are configured to have the functional units depicted in FIG. 1. When the functional units are separate apparatuses, connections between the apparatuses may be implemented by communication via Bluetooth (registered trademark), for example, regardless of whether the communication is wired or wireless.

As described above, according to the search apparatus, the search method, the search program, and the computer-readable recording medium according to the present embodiment, a suitable combination can be designated even when plural facilities are searched for, and the user can optimize the selection of facilities.

### First Example

A first example of the present invention will be described. The first example is one example where the search apparatus according to the present invention is embodied, for example, by a navigation apparatus equipped on a mobile object such as a vehicle (including four-wheel vehicles and two-wheel vehicles).

### (Hardware Configuration of Navigation Apparatus)

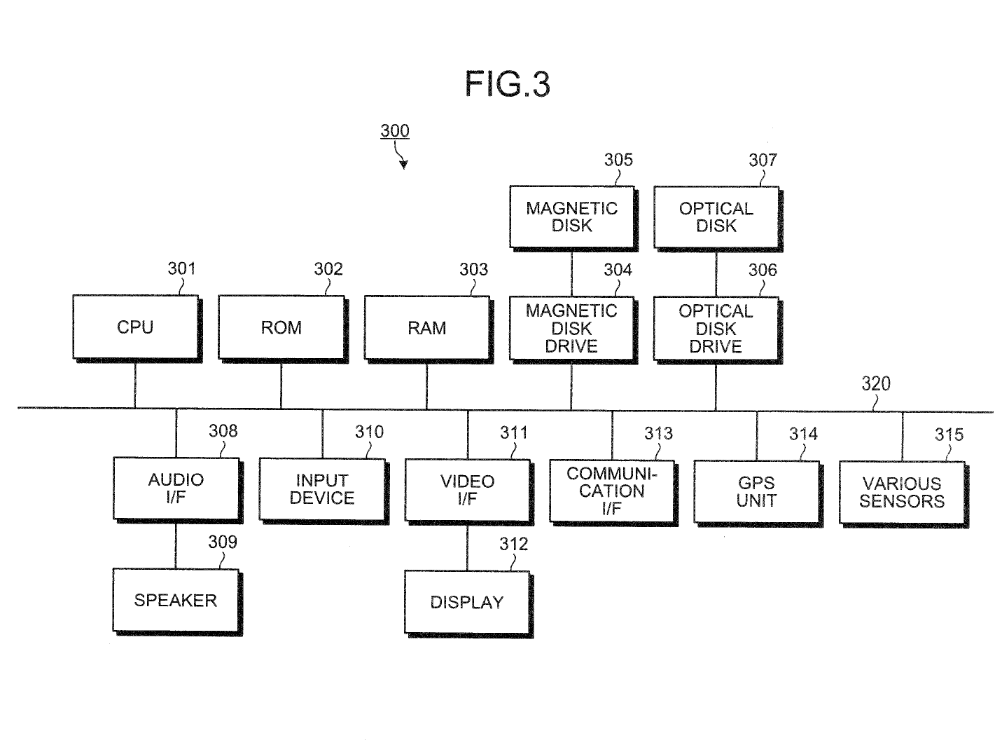

A hardware configuration of a navigation apparatus 300 according to the first example will be described. FIG. 3 is a block diagram of a hardware configuration of the navigation apparatus according to the first example.

As depicted in FIG. 3, the navigation apparatus 300 includes a CPU 301, a ROM 302, a RAM 303, a magnetic disk drive 304, a magnetic disk 305, an optical disk drive 306, an optical disk 307, an audio I/F (interface) 308, a speaker 309, an input device 310, a video I/F 311, a display 312, a communication I/F 313, a GPS unit 314, and various sensors 315, respectively connected through a bus 320.

The CPU 301 governs overall control the navigation apparatus 300. The ROM 302 stores therein various programs such as a boot program, a current location calculating program, a route search program, a route guidance program, an audio generating program, and a display control program. The RAM 303 is used as a work area for the CPU 301.

The current location calculating program calculates a current location of a vehicle (a current location of the navigation apparatus 300), based on, for example, information output from the GPS unit 314 and the various sensors 315 described hereinafter.

The route search program searches for an optimum route from a start point to a destination, using map information and the like recorded on the magnetic disk 305 described hereinafter. Here, the optimum route is the shortest (or fastest) route to a destination, a route that most satisfies conditions designated by the user, and the like.

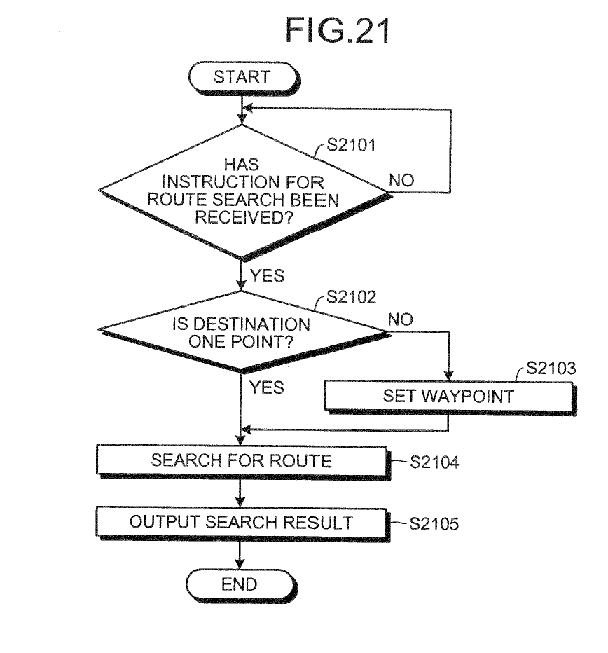

Specifically, for example, the route search program searches for the optimum route by searching for points based on search conditions concerning the destination, the start point, waypoints, and the like input by the user. The details of the processing will be described with reference to FIG. 9 and FIG. 21. More specifically, for example, the route search program receives an input of search conditions, such as shops and genres, concerning waypoints (or the destination) that the user wants to stop by, and searches for the waypoints based on the search conditions. The route search program may search for the optimum route by receiving from the user, a route search instruction that is based on the search result.

The route guidance program generates real-time route guidance information based on route information retrieved by an execution of the route search program, current vehicle location information calculated by an execution of the current location calculating program, and map information read out from the magnetic disk 305 described hereinafter. The route guidance information generated by the execution of the route guidance program is output to the audio I/F 308 and the video I/F 311 via the CPU 301.

The audio generating program generates tone and audio information corresponding to a pattern. That is, the audio generating program sets a virtual audio source corresponding to a navigation point and generates audio guidance information, based on the route guidance information generated by the execution of the route guidance program. The generated audio guidance information is output to the audio I/F 308 via the CPU 301.

The display control program determines the form of display of map information and content displayed on the display 312 by the video I/F 311, and displays the map information and the content according to the determined form.

The magnetic disk drive 304 controls the reading and writing of data with respect to the magnetic disk 305 under the control of the CPU 301. The magnetic disk 305 records the data written under the control of the magnetic disk drive 304. The magnetic disk 305 may be HD (hard disk) or FD (flexible disk), for example.

One example of the information recorded on the magnetic disk 305 includes the map information used for the route search and route guidance. The map information includes background data representing terrestrial objects (features) such as buildings, rivers, and terrestrial surfaces and road shape data representing the shapes of roads. The map information is depicted two-dimensionally or three-dimensionally on the display screen of the display 312.

Although the map information is recorded on the magnetic disk 305 in the first example, the map information may be recorded on the optical disk 307 described hereinafter. The map information is not limited to that stored in integral components of the hardware of the navigation apparatus 300 and may be information stored externally with respect to the navigation apparatus 300. In this case, for example, the navigation apparatus 300 obtains the map information via a network through a communication I/F 313. The obtained map information is stored to the RAM 303 and the like.

The optical disk drive 306 controls the reading and writing of data with respect to the optical disk 307 under the control of the CPU 301. The optical disk 307 is a removable recording medium having data read out under the control of the optical disk drive 306. A writable recording medium may be utilized for the optical disk 307. The removable recording medium may be a medium other than the optical disk 307, such as an MO and a memory card.

The audio I/F 308 is connected to a speaker 309 for audio output. The speaker 309 outputs audio.

The input device 310 may be a remote controller equipped with keys for inputting characters, numerals, and various instructions; a keyboard; a mouse; a touch panel; and the like.

The video I/F 311 is connected to the display 312. Specifically, the video I/F 311 is made up of, for example, a graphic controller that generally controls the display 312, a buffer memory such as VRAM (Video RAM) that temporarily records immediately displayable image information, and a control IC that controls the display 312 based on image data output from a graphic controller.

The display 312 displays icons, a cursor, menus, windows, or various data such as characters and images. For example, a CRT, a TFT, a liquid crystal display, and a plasma display may be employed as the display 312. The vehicle may be equipped with a plurality of the displays 312, including, for example, one for the driver and one for passengers sitting in the back seat.

The communication I/F 313 is wirelessly connected to a network and functions as an interface between the navigation apparatus 300 and the CPU 301. The communication I/F 313 is wirelessly connected to a communication network such as the internet and also functions as an interface between this communication network and the CPU 301.

The communication network includes LAN, WAN, public line network, portable telephone network, etc. Specifically, the communication I/F 313 is made up of, for example, an FM tuner, VICS (Vehicle Information and Communication System)/beacon receiver, a wireless navigation device, and other navigation devices, and acquires road traffic information, such as road congestion and traffic regulations, distributed from VICS centers. VICS is a registered trademark.

The GPS unit 314 receives signals from GPS satellites and outputs information indicative of the current position of the vehicle. The information output from the GPS unit 314 is used along with values output from the various sensors 315 (described hereinafter) when the CPU 301 calculates the current position of the vehicle. The information indicative of the current position is information specifying one point on map information, for example, latitude/longitude and altitude.

The various sensors 315 include that output information for determining the position and behavior of the vehicle, such as a vehicular speed sensor, an acceleration sensor, and an angular-speed sensor. The values output from the various sensors 315 are used by the CPU 301 for calculating the current position of the vehicle and calculating changes in velocity and direction.

The first example describes the navigation apparatus 300 equipped on a vehicle; however, the search apparatus according to the present invention may be embodied by a portable terminal, a PC (Personal Computer), and the like of a user.

The respective functions of the input unit 101, the extraction unit 102, the calculating unit 103, the designating unit 104, the generating unit 105, the output unit 106, and the determining unit 107 included in the search apparatus 100 depicted in FIG. 1 are implemented by the CPU 301 executing predetermined programs to control the units of the navigation apparatus 300 with the use of programs and data recorded on the ROM 302, the RAM 303, the magnetic disk 305, the optical disk 307 and the like in the navigation apparatus 300 depicted in FIG. 3.

That is, the navigation apparatus 300 of the first example, by executing a display control program recorded in the ROM 302 as the recording medium in the navigation apparatus 300, can execute the functions equipped in the search apparatus 100 depicted in FIG. 1 by the procedure depicted in FIG. 2.

### (Overview of Search Condition Designation)

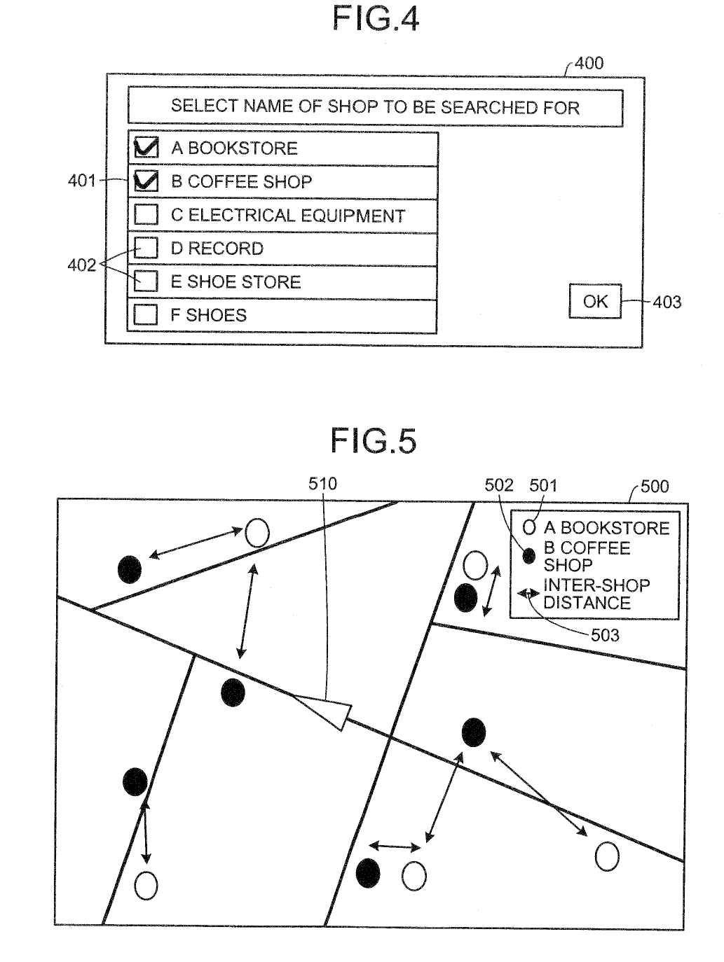

Next, an overview of the designation of search conditions with respect to the navigation apparatus 300 of the first example will be described with reference to FIG. 4. FIG. 4 is a diagram of one example of a search condition designation screen in the navigation apparatus of the first example.

As depicted in FIG. 4, a search condition designation screen 400 includes a search shop group 401, selection boxes 402, and an OK button 403, and is displayed to the user, for example, on the display 312 depicted in FIG. 3.

The search shop group 401 depicts shops and the like at a point that is a search candidate. Specifically, for example, the search shop group 401 depicts the names of shops that the user wishes to search, namely, A bookstore, B coffee shop, C electrical equipment, D records, E shoe store, F shoes as depicted in FIG. 4. For example, the shops may be chain stores, and plural shops may be indicated on a map.

The selection box 402 is used to receive from the user, a selection of a shop from among shops that are depicted in the search shop group 401 and are at points that are search candidates. Specifically, for example, the selection of a shop may be received via the selection box through user operation of a touch panel, and in FIG. 4, the A bookstore and the B coffee shop are selected. Although in the explanation of FIG. 4, the selection of shops at two points that are search candidates has been received, the number of search candidates may also be one, or three or more.

The OK button 403 is used to indicate a completion of the selection of the shops by the user. That is, the user selects from the search shop group 401 by using the selection box 402, the names of shops to be searched for, and selects the OK button 403 to cause the navigation apparatus 300 to search for the shops.

In the explanation of FIG. 4, as a search condition, the user selects from the search shop group 401, shops at the points that are the search candidates. However, the user may select genres at the points that are search candidates, and further may select shops and genres. That is, provided the selection is of a keyword about the point that is a search candidate, the keyword is not limited and further, various combinations may be selected. In specifying the search condition, the names of shops and genres may be input by a manipulation of, for example, the input device 310. Specifically, for example, when a combination of genres is selected to be searched for, a movie theater located near a public parking lot can be searched for by selecting a combination of a public parking lot and a movie theater. Further, a park located near a restroom or a park with a restroom can be searched for by selecting a combination of a restroom and a park.

### (Overview of Search Result)

Next, an overview of the search result of the navigation apparatus 300 according to the first example will be described with reference to FIGS. 5 to 8. FIG. 5 is a diagram of one example of a display screen displaying a search result of the navigation apparatus according to the first example.

As depicted in FIG. 5, a search result display screen 500 depicts, on a map, the A bookstore 501 and the B coffee shop 502 retrieved according to the search condition depicted in FIG. 4. The search result display screen 500 also indicates an inter-shop distance 503 between the A bookstore 501 and the B coffee shop 502, and a vehicle location 510 of the user.

Specifically, for example, the navigation apparatus 300 searches for, in a predetermined area on the map relative to the vehicle location 510 of the vehicle equipped with the navigation apparatus 300, the A bookstore 501 and the B coffee shop 502, which, in FIG. 4, are the shops that the user has selected and wishes to search for. Then, the navigation apparatus 300 calculates the inter-shop distance 503 between the A bookstores 501 and the B coffee shops 502, and displays the search result as the search result display screen 500. In the explanation of FIG. 5, a search result for the A bookstore 501 and the B coffee shop 502, which are the names of shops that the user wants to search for, is described. When the user wants to search for and selects a genre instead of the name of a shop, for example, in a case where genres such as “bookstore” and “coffee shop” are selected, bookstores other than the A bookstore 501 and coffee shops other than the B coffee shop are also retrieved and displayed together with the A bookstore 501 and B bookstore 502. A selection may be made of a combination of a genre and the name of a shop, such as “bookstore”, the genre to be searched for, and the B coffee shop, the name of the shop to be searched for.

Here, if the user is to drop by (go by way of) the retrieved shop, it is inefficient for the user to select the A bookstore 501 and the B coffee shop 502 that are located far away from each other and proceed. In the first example, the navigation apparatus 300 outputs, as the search result, a combination of the A bookstore 501 and the B coffee shop 502 between which the inter-shop distance 503 is equal to or less than a predetermined value.

Although not depicted in the figures, when, for example, three shops are searched for based on the search condition, the navigation apparatus 300, executes a search for the three user-selected shops with respect to a map covering a predetermined distance from the vehicle location of the vehicle equipped with the navigation apparatus 300. Next, the navigation apparatus 300 calculates inter-shop distances between the retrieved shops.

A combination of three shops having two (or three) inter-shop distances that are equal to or less than a predetermined value may be output as the search result. In the case of four or more shops, a combination having three (or four, five, six) inter-shop distances that are equal to or less than the predetermined value may be output as the search result.

Alternatively, when, for example, three shops are searched for, any one of the three shops may be retrieved and relative to the shop retrieved, a shop that is located at distance equal to or less than a predetermined distance may be retrieved. Subsequently, relative to the two shops retrieved, another shop that is located at a distance equal to or less than the predetermined value may be retrieved.

As described above, efficient search processing can be realized by reducing the number of searches by searching for the shops one by one. In particular, when the number of shops initially retrieved is small, the efficiency improves. Alternatively, instead of searching for shops one by one, a combination of two shops may be searched for and from the combination, a shop located at a distance equal to or less than a predetermined value may be retrieved.

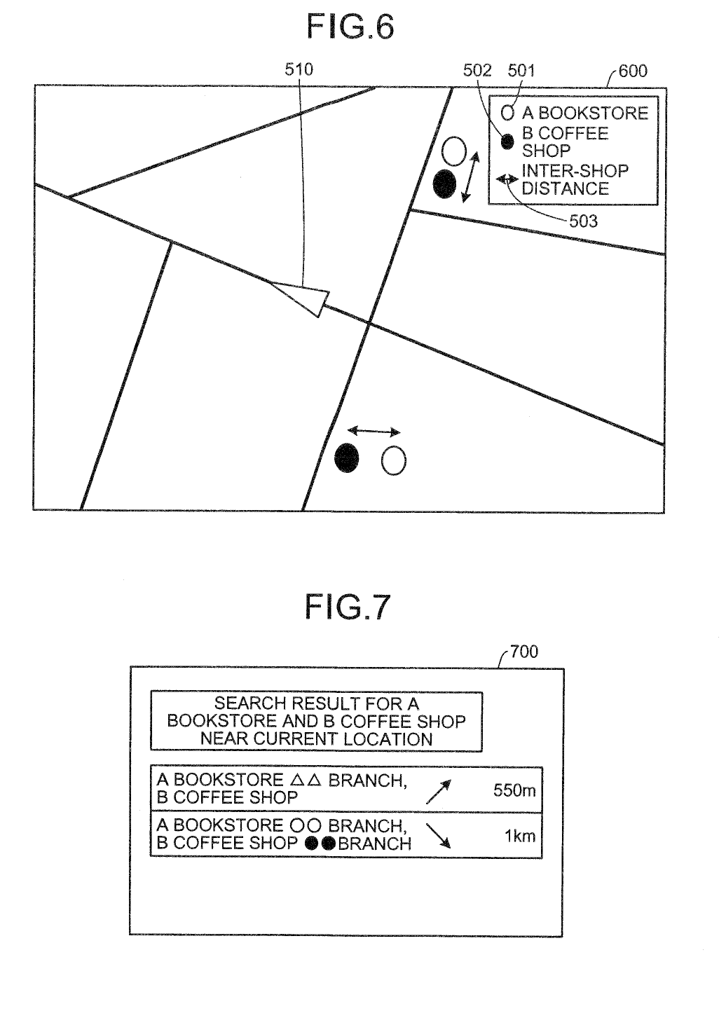

FIG. 6 is a diagram (part one) of one example of a combination of the A bookstore and the B coffee shop, namely, the search result according to the first example. As depicted in FIG. 6, a search result display screen 600 depicts a combination of the A bookstore 501 and the B coffee shop 502 between which the inter-shop distance 503 is equal to or less than the predetermined value.

FIG. 7 is a diagram (part two) of one example of a combination of the A bookstore and the B coffee shop, namely, the search result according to the first example. As depicted in FIG. 7, instead of the map display depicted in FIG. 6, a search result display screen 700 depicts a combination of the A bookstore 501 and the B coffee shop 502 between which the inter-shop distance 503 is equal to or less than the predetermined value, a direction (for example, the arrow in the figure) from the current location to the combination of the A bookstore 501 and the B coffee shop 502, a distance to the combination of the A bookstore 501 and the B coffee shop 502.

Here, the distance to the combination of the A bookstore 501 and the B coffee shop 502 may be, for example, a distance between the current location and an intermediate point of a line connecting the A bookstore 501 and the B coffee shop 502. Alternatively, instead of displaying the distance to the combination of the A bookstore 501 and the B coffee shop 502, a distance to the A bookstore 501 as well as a distance to B bookstore 502 may be displayed together.

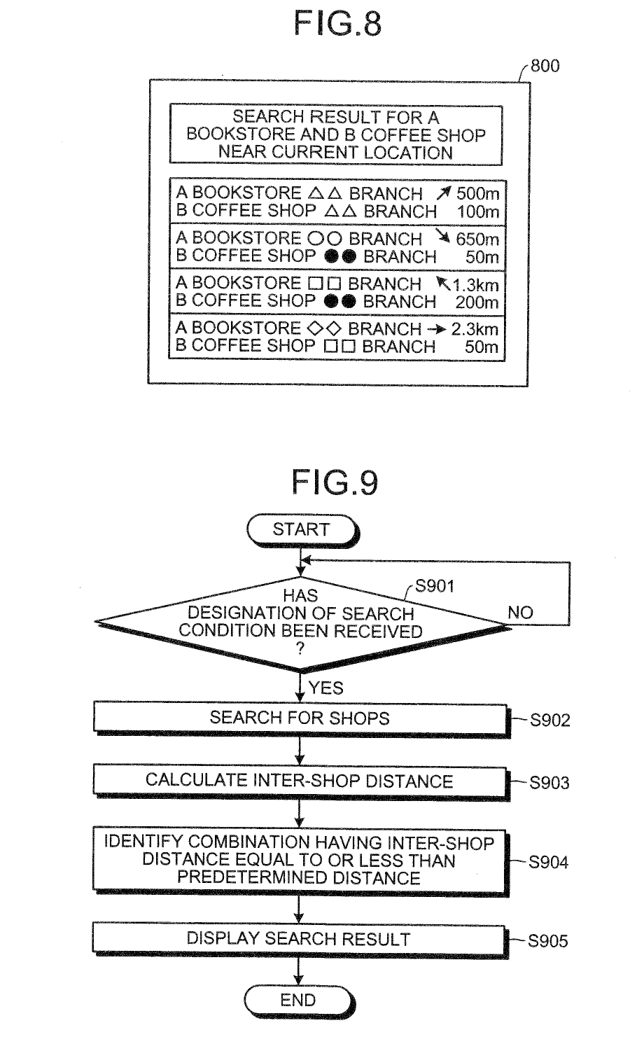

FIG. 8 is a diagram (part three) of one example of a combination of the A bookstore and the B coffee shop, namely, the search result according to the first example. As depicted in FIG. 8, a search result display screen 800 riot only displays a combination of the A bookstore 501 and the B coffee shop 502 between which the inter-shop distance 503 is equal to or less than the predetermined value but also displays the distance from the current location to the A bookstore 501 as well as the distance to the B coffee shop 502 nearest to the A bookstore 501.

In the explanation of FIG. 8, the distance from the current location to the A bookstore 501 is displayed, but the distance from the current location may be the distance to either the A bookstore 501 or the B coffee shop 502 of the search.

### (Details of Processing by the Navigation Apparatus 300)

Next, details of the processing by the navigation apparatus 300 according to the first example will be described with reference to FIG. 9. FIG. 9 is a flowchart of the processing by the navigation apparatus according to the first example. As depicted in the flowchart of FIG. 9, first, it is determined whether the input device 310 has received designation of a search condition (step S901). For example, the search condition may be designated by receiving an input from the user, or receiving through a manipulation of the touch-panel display 312, an input of shop information that the user wishes to search for.

Waiting occurs at step S901, and when designation of a search condition is received (step S901: YES), the CPU 301 searches the map information for the shop designated at step S901 (step S902).

Then, the CPU 301 calculates the inter-shop distance 503 for the shops retrieved at step S902 (step S903). Specifically, for example, in the calculation of the inter-shop distance 503, different kinds of inter-shop distances 503 may be calculated using detailed information concerning the points of the shops calculated at step S902. More specifically, for example, the distance between the A bookstore 501 and the B coffee shop 502 depicted in FIG. 4 to FIG. 8 may be calculated.

Next, a combination having an inter-shop distance 503 equal to or less than a predetermined distance is identified by causing the CPU 301 to compare the predetermined distance and the inter-shop distances 503 calculated at step S903 (step S904). In other words, among combinations of the A bookstore 501 and the B coffee shop 502, a combination the A bookstore 501 and the B coffee shop 502 that are nearby is identified.

Then, the display 312, using the combination identified at step S904, displays the results of the search based on the search condition designated at step S901 (step S905), and a series of the processing ends.

As described above, the navigation apparatus according to the first example can output a combination of the closely-located shops as a search result even when plural shops are searched for, and thus, the user can select the optimum combination without being at a loss.

### Second Example

Next, a second example according to the present invention will be described. In the second example, regarding the search of the shops performed by the navigation apparatus 300 described in the first example, a case will be described in which plural shops are not searched for concurrently but rather are searched for one by one. The functional configuration of the navigation apparatus 300 according to the second example is substantially similar to that depicted in FIG. 3, and the designation of the search conditions is substantially similar to that depicted in FIG. 4, and thus, the description therefor is omitted.

### (Overview of Search Result)

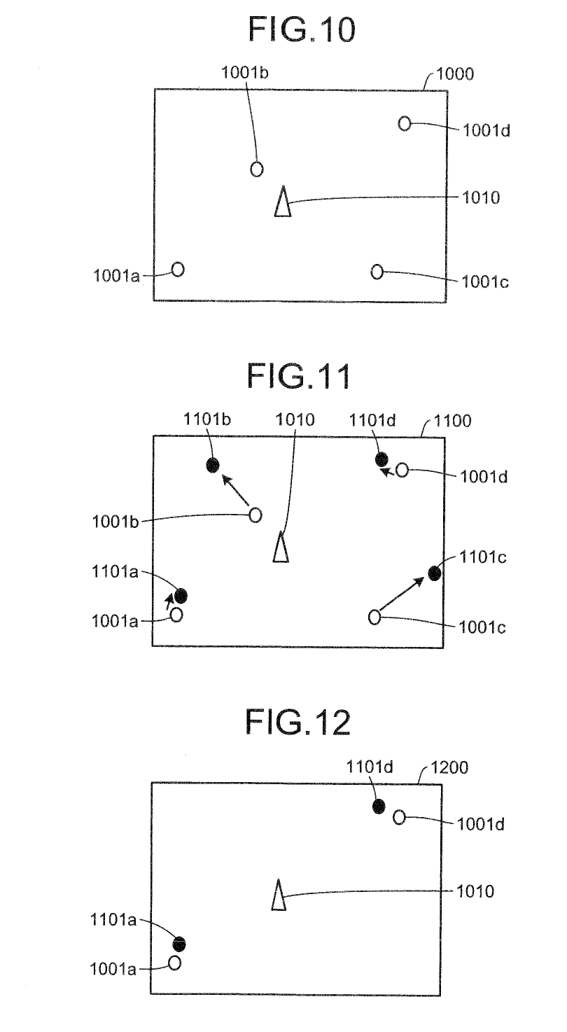

An overview of a search result of the navigation apparatus 300 according to the second example will be described with reference to FIG. 10 to FIG. 12. The search performed by the navigation apparatus 300 according to the second example is a case where, in the search of the A bookstore 501 and the B coffee shop 502 depicted in FIG. 4 to FIG. 8 according to the first example, the A bookstore 501 is searched for and thereafter the B coffee shop 502 is searched for and a combination having an inter-shop distance that is equal to or less than a predetermined distance is identified.

FIG. 10 is a diagram of one example of a display screen of a search result for the A bookstore, according to the navigation apparatus of the second example. As depicted in FIG. 10, a search result display screen 1000 indicates a vehicle location 1010 of the user and A bookstores 1001 (1001a, 1001b, 1001c, 1001d).

That is, the search result display screen 1000 depicts the search result obtained by causing the navigation apparatus 300 to search a map covering a vicinity the vehicle location 1010 for the A bookstores 1001 (1001a, 1001b, 1001c, 1001d).

FIG. 11 is a diagram of one example of a display screen of a search result for the B coffee shop, according to the navigation apparatus of the second example. As depicted in FIG. 11, a search result display screen 1100 indicates the vehicle location 1010, the A bookstores 1001 (1001a, 1001b, 1001C, 1001d), and B coffee shops 1101 (1101a, 1101b, 1101C, 1101d) nearest to the A bookstores 1001 (1001a, 1001b, 1001c, 1001d).

That is, the search result display screen 1100 depicts a search result obtained by searching for each of the nearest B coffee shops 1101 (1101a, 1101b, 1101c, 1101d) after the navigation apparatus 300 has searched for the A bookstores 1001 (1001a, 1001b, 1001c, 1001d).

FIG. 12 is a diagram of one example of a display screen of a search result for a combination of the A bookstore and the B coffee shop, according to the navigation apparatus of the second example. As depicted in FIG. 12, a search result display screen 1200 indicates the vehicle location 1010 of the user, the A bookstores 1001a, 1001d, and the B coffee shops 1101a, 1101d.

That is, on the search result display screen 1200, the navigation apparatus 300 depicts, as the search result, the combination of the A bookstore 1001a and the B coffee shop 1101a and the combination of the A bookstore 1001d and the B coffee shop 1101d, both combinations having an inter-shop distance equal to or less than a predetermined distance.

As for the details of the processing by the navigation apparatus 300 according to the second example, at step S902 in the flowchart depicted in FIG. 9, when shops are searched for, the A bookstore 1001 is searched for and thereafter the B coffee shop 1101 nearest to the retrieved A bookstore is searched for. Alternatively, instead of searching for A bookstore 1001 and thereafter searching for the B coffee shop 1101 nearest to the retrieved A bookstore 1001, the B coffee shop 1101 may be searched for and thereafter the A bookstore 1001 nearest to the retrieved B coffee shop 1101 may be searched for.

Therefore, even when the shops are of plural types, if the shops are searched for according to type, the number of shops retrieved first is greater than the number of searches subsequently performed for shops of types different from the type of the shops first retrieved. That is, the processing load for the search processing can be further reduced when the number of the shops retrieved at first is small.

As described above, even when plural types of shops are searched for, the navigation apparatus according to the second example can constrain the number of combinations of shops of different types to be at most the number of the shops first retrieved and can reduce the load of the search processing.

### Third Example

Next, a third example according to the present invention will be described. In the search for the shops performed by the navigation apparatus 300 described in the first example and the second example, the third example describes a case where a combination of shops on the same premises is searched for. The functional configuration of the navigation apparatus 300 according to the third example is substantially similar to that depicted in FIG. 3, the designation of the search conditions is almost similar to FIG. 4, and thus, the description therefor is omitted.

### (Overview of Premises Data)

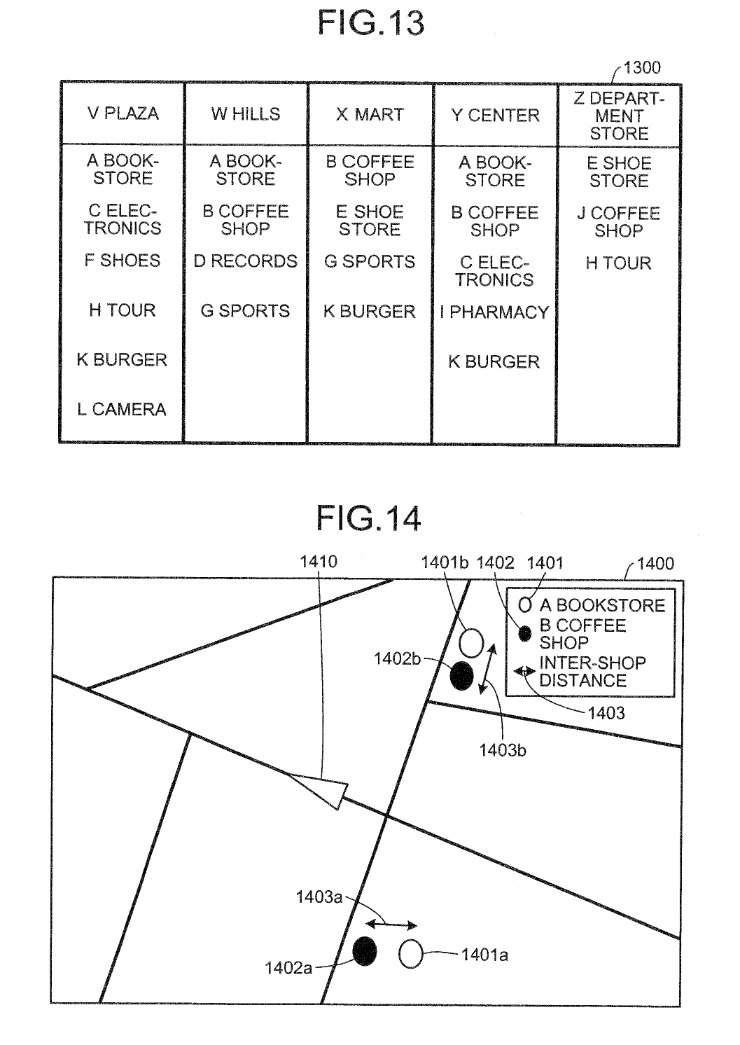

First, premises data indicative of information concerning shops on the same premises, according to the third example will be described with reference to FIG. 13. FIG. 13 is a diagram of one example of premises data indicative of information concerning shops on the same premises, according to the third example.

As depicted in FIG. 13, premises data 1300 includes, according to complex facility, information concerning the shops at each complex facility. That is, the navigation apparatus 300, by referring to the premises data 1300, may search for a complex facility that has the shop designated by the search conditions depicted in FIG. 4. Specifically, for example, the complex facilities including the A bookstore and the B coffee shop are W hills and Y center in FIG. 13.

Alternatively, instead of by reference to the premises data 1300, the shops may be determined to be on the same premises (in the same building) when the address of each shop is the same based on the location information concerning each of the searched shops. Further, the shops may be determined to be on the same premises (in the same building) when the shops have a common parking lot based on the location information concerning each shop. Furthermore, a combination of shops having identically-shaped building data may be determined to be on the same premises (in the same building) by referring to building data used for displaying each of the retrieved shops on a map.

A positional relationship between shops may be used to determine whether shops retrieved in combination are on the same premises (in the same building).

FIG. 14 is a diagram of one example of a display screen of a search result according to the navigation apparatus of the third example. As depicted in FIG. 14, a search result display screen 1400 indicates a vehicle location 1410 of the user, A bookstores 1401 (1401a, 1401b), and B coffee shops (1402a, 1402b), having inter-shop distances 1403 (1403a, 1403b).

The inter-shop distances 1403 (1403a, 1403b) between the A bookstores 1401 (1401a, 1401b) and the B coffee shops (1402a, 1402b) are equal to or less than a predetermined distance. Here, as depicted in FIG. 14, it may be assumed that the A bookstore 1401a and the B coffee shop 1402a are not on the same premises (in the same building) since there is a road between the A bookstore 1401a and the B coffee shop 1402a, and it may be assumed that the A bookstore 1401b and the B coffee shop 1402b are on the same premises (in the same building) since there is no road between the A bookstore 1401b and the B coffee shop 1402b. As described, the determination of whether shops are on the same premises (in the same building) may be made based on whether a road exists between the neighboring shops.

As for details of the processing by the navigation apparatus 300 according to the third example, at step S903 and step S904 in the flowchart depicted in FIG. 9, the inter-shop distances 1403 are calculated and compared with a predetermined distance, and thereafter it is determined whether shops having an inter-shop distance 1403 equal to or less than a predetermined distance are on the same premises (in the same building).

As described, the navigation apparatus according to the third example can easily identify the combination of shops on the same premises (in the same building). The user can know the combination of shops that the user can efficiently use because the combination of shops on the same premises (in the same building) is identified.

### Fourth Example

Next, the fourth example according to the present invention will be described. The fourth example describes a case in which a route search is performed with respect to shops retrieved by the navigation apparatus 300 described in the first to third examples. The functional configuration of the navigation apparatus 300 according to the fourth example is substantially similar to that depicted in FIG. 3, and thus, description therefor is omitted.

Specifically, for example, when the A bookstore and the B coffee shop are retrieved based on the search conditions supplied from the user, the navigation apparatus 300 searches for a route by setting either the A bookstore or the B coffee shop as a waypoint and setting the other as a destination. In the description of the fourth example, the two shops are explained as a waypoint and a destination; however, even in the case of three or more shops, the order of plural waypoints that the user drops by may be set followed by a route search.

Here, when plural combinations of the A bookstore and the B coffee shop are retrieved, a combination for searching for a route by the navigation apparatus 300 may be selected. The selection may be made by the navigation apparatus 300, for example, by a selection of the combination having shops located closest to the current location of the vehicle, by a selection the optimum route upon comparing the required time and the distance to the B coffee shop by way of the A bookstore from the current location with the required time to and the distance to the A bookstore by way of the B coffee shop.

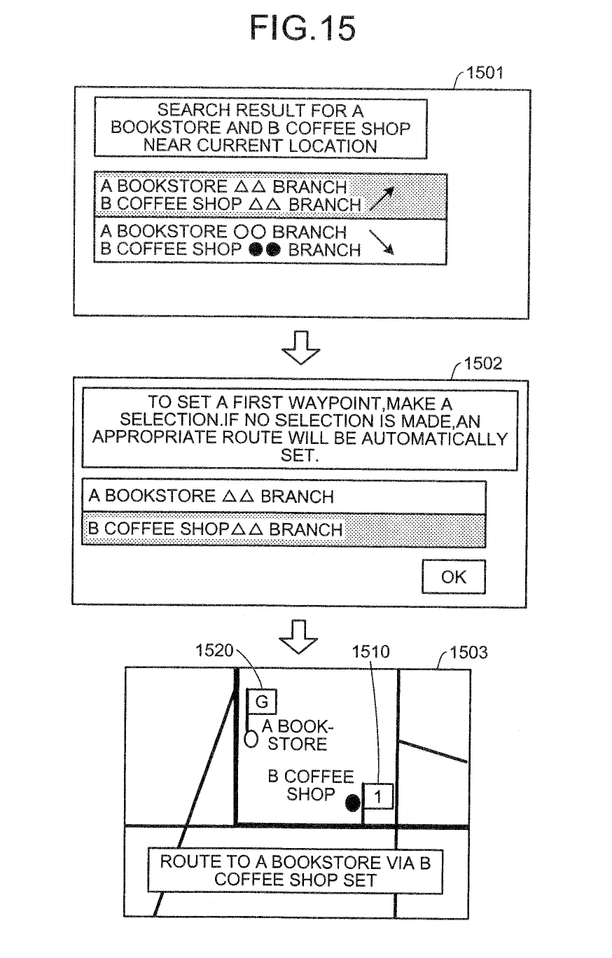

When plural combinations of the A bookstore and the B coffee shop are retrieved, the user may make a selection. Specifically, for example, the user may select a combination of the A bookstore and the B coffee shop using a selection screen such as that depicted in FIG. 15.

FIG. 15 is a diagram of one example of a selection of waypoints, according to the navigation apparatus of the fourth example. As depicted in FIG. 15, a selection screen 1501 is a screen for making a selection among the combinations of the A bookstores and the B coffee shops depicted in the search result generated by the navigation apparatus 300.

When one combination is selected from among the combinations on the selection screen 1501, a selection screen 1502 is displayed to enable selection of a shop that the user is to drop by first. Here, in FIG. 15, a selection is made in which ΔΔ branch of the A bookstore is the destination by way of the waypoint, ΔΔ branch of the B coffee shop.

Thereafter, a waypoint 1510 and a destination 1520 are indicated on a destination setting screen 1503.

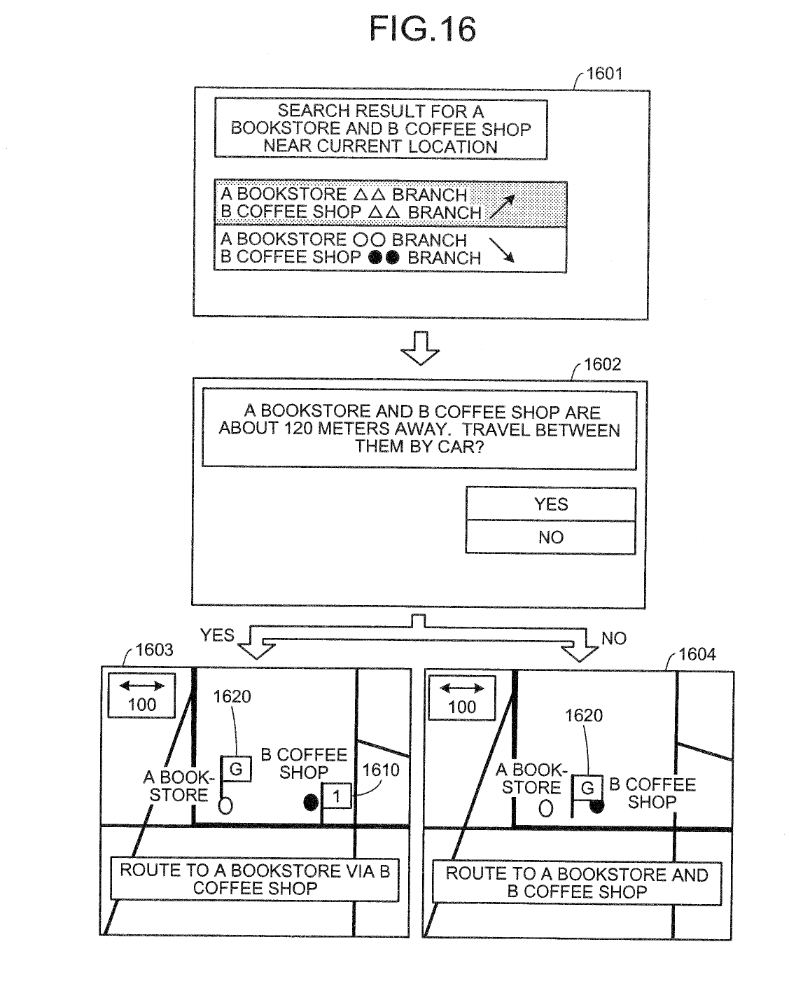

The shops retrieved by the navigation apparatus 300 in the fourth example may be located in proximity to each other (or on the same premises) as in the first to the third examples, and further, the user may determine whether the destination is one point as depicted in FIG. 16.

FIG. 16 is a diagram of one example of a setting of the destination, according to the navigation apparatus of the fourth example. As depicted in FIG. 16, a selection screen 1601 is a screen similar to the selection screen 1501 depicted in FIG. 15 for making selection of a combination among the combinations of the A bookstores and the B coffee shops depicted in the search result generated by the navigation apparatus 300.

When one combination is selected from among the combinations on the selection screen 1601, a selection screen 1602 is displayed to enable selection of whether the destination is one point. Here, in FIG. 16, the distance between the shops is indicated, and the user selects whether the user will travel between the shops by vehicle, thereby causing a destination setting screen 1603 or a destination setting screen 1604 to appear.

Specifically, for example, when the user travels between the A bookstore and the B coffee shop by vehicle, a destination 1620 is not one point. Either the A bookstore or the B coffee shop may be set as the destination and the one not set as the destination 1620 is set as a waypoint 1610. The selection of the waypoint 1610 and the destination 1620 may be made in the same way as depicted in FIG. 15. When the user does not travel between the A bookstore and the B coffee shop by vehicle, the destination 1620 is one point.

In the explanation of FIG. 16, the user selects whether the destination 1620 is set as one point, but when the distance(s) between the shops in the combination selected in the selection screen 1601 are equal to or less than a predetermined value, the destination 1620 may be set as one point automatically. Therefore, the destination setting screen 1603 or the destination setting screen 1604 can be rapidly displayed without displaying the selection screen 1602 and waiting for selection by the user.

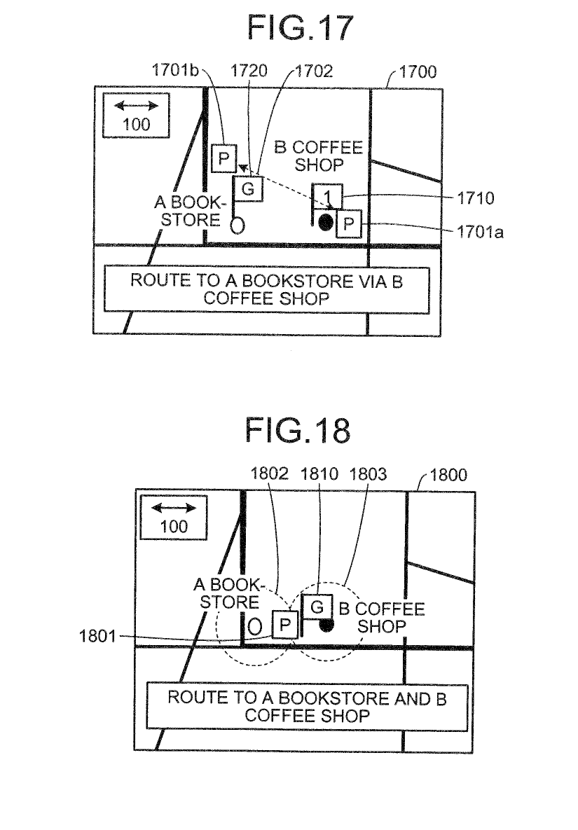

Instead of determining whether the destination 1620 is set as one point by allowing the user to select whether the destination 1620 is set as one point as depicted in FIG. 16, a determination may be made based on respective parking lots for the shops in the combination selected in the selection screen 1601 or a parking lot near the shops as depicted in FIG. 17 to FIG. 19.

FIG. 17 is a diagram (part one) of one example of the setting of the destination using the point of the parking lot, according to the navigation apparatus of the fourth example. As depicted in FIG. 17, a destination setting screen 1700 indicates a waypoint 1710, a destination 1720, parking lots 1701 (1701a, 1701b) near the shops. Specifically, for example, the destination 1710 is not set as one point because there is an inter-parking lot distance 1702 that is equal to or more than a predetermined distance between the parking lot 1701a near the waypoint 1710 and the parking lot 1701b near the destination 1720.

FIG. 18 is a diagram (part two) of one example of the setting of the destination using the point of the parking lot according to the navigation apparatus of the fourth example. In FIG. 18, a destination setting screen 1800 indicates a destination 1810 and a parking lot 1801 near the shops. Specifically, for example, the destination 1810 is set as one point because the parking lot 1801 is within predetermined distances 1802, 1803 from each shop.

As depicted in FIG. 17 and FIG. 18, instead of using the inter-parking lot distance between parking lots near the shops and the distances to the parking lots, parking lot data of parking lots may be used to enable the user to park the vehicle when using each shop.

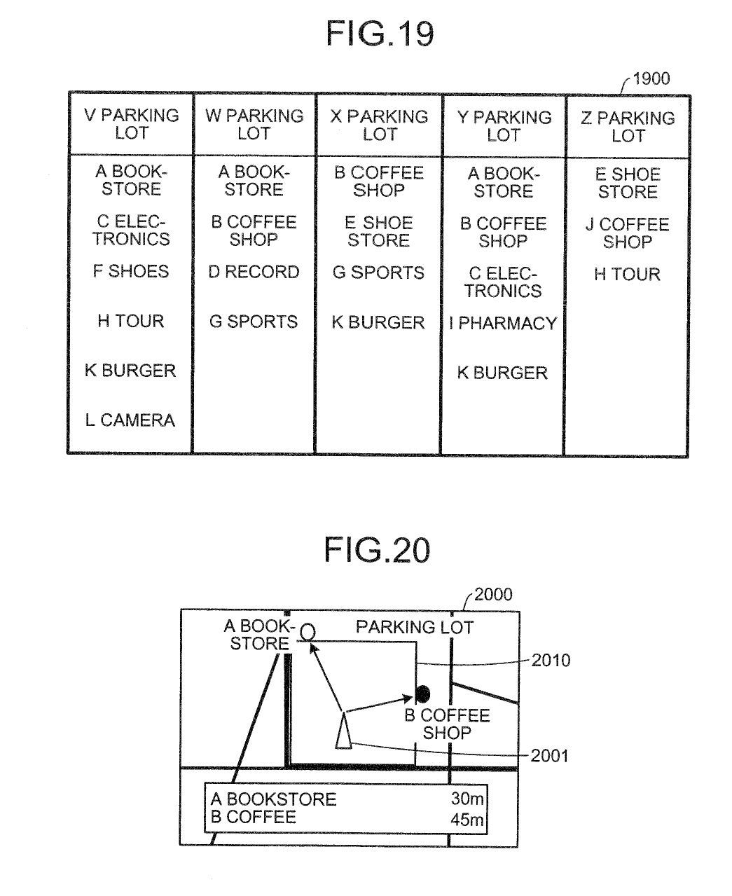

FIG. 19 is a diagram of one example of shops subject to a search according to the navigation apparatus of the fourth example and the parking lot data of parking lots affiliated with the shops. Parking lot data 1900 depicted in FIG. 19 includes, according to parking lot, information concerning the shops affiliated with the parking lots. That is, the navigation apparatus 300 can search for parking lots affiliated with the A bookstore and the B coffee shop, i.e., W parking lot and Y parking lot, by referring to the parking lot data, and an appropriate parking lot may be set as the destination upon comparison of the time required to reach the parking lot and the distance from the current location.

When plural shops are set as one destination, the navigation apparatus 300 may provide guidance concerning each shop upon arrival at the destination, immediately before arrival at the destination, or at the start of the route guidance as depicted in FIG. 20.

FIG. 20 is a diagram of one example of shop guidance according to the navigation apparatus of the fourth example. As depicted in FIG. 20, a guidance screen 2000 indicates a vehicle location 2001 of the user vehicle that has arrived at a parking lot 2010 common to the A bookstore and the B coffee shop, and displays the distances to each of the shops. The user refers to these distances, and can appropriately choose the shop that the user will go to first.

Audio information may be output instead of the display of the guidance screen 2000. Specifically, for example, following audio may be output: “We have arrived at the destination. The ΔΔ branch of the A bookstore is 10 meters to the west, and the ΔΔ branch of the B coffee shop is 25 meters to the east from here.” Even when the destination is not one point, where a waypoint and a destination are set, following audio may be output: “We have arrived at the OO branch of the A bookstore. The next destination, the ΔΔ branch of the B coffee shop, is 10 meters east from here.”

### (Details of Processing by the Navigation Apparatus 300)

Next, details of processing by the navigation apparatus 300 according to the fourth example will be described with reference to FIG. 21. FIG. 21 is a flowchart of the processing by the navigation apparatus according to the fourth example. As depicted in the flowchart of FIG. 21, first, it is determined whether the input device 310 has received an instruction for a route search (step S2101). The instruction for a route search may be given, for example, by receiving an input from the user based on the search result in the first example as described above.

Waiting occurs at step S2101, when an instruction for a route search is received (step S2101: YES), the CPU 301 determines whether the destination of the route search instructed at step S2101 is one destination (step S2102). Specifically, for example, the determination of one destination may be made according to the method depicted in FIG. 16 to FIG. 19 when the instruction of the route search to the A bookstore and the B coffee shop has been received at step S2101.

When the destination is one point at step S2102 (step S2102: YES), the CPU 301 searches for a route to the destination (step S2104).

When the destination is not one point at step S2102 (step S2102: NO), the CPU 301 sets a waypoint (step S2103), and searches for a route to the destination by way of the waypoint (step S2104).

Subsequently, a search result is output via the display 312 and the speaker 309 (step S2105), and a series of the processing ends.

As described, even when plural shops are retrieved, the navigation apparatus according to the fourth example enables selection of an appropriate combination and provision of route guidance, so that the user can set optimally waypoints of shops.

Each of the functions in the first to fourth examples may be combined and embodied. Specifically, for example, a combination of the first example and the second example enables the user to select the optimum combination while constraining the number of combinations of the shops to be searched.

For example, a combination of the third example and the fourth example enables appropriate selection whether the retrieved shops in a combination are on the same premises or have a common parking lot.

As described above, according to the present embodiment, an appropriate combination can be determined even when plural types of shops are searched for, enabling the user optimally select facilities.

A combination of shops in proximity to one another can be output as a search result even when plural types of shops are searched for, enabling the user select the optimum combination without being at a loss.

Even when plural types of shops are searched for, the number of combinations of different types of shops can be constrained to be no more than the number of shops retrieved first, enabling the load of the search processing to be reduced.

A combination of shops on the same premises (in the same building) can be identified easily. The user can know the combination of shops that can be used efficiently because a combination of shops on the same premises (in the same building) is identified.

Furthermore, even when plural shops are retrieved, an appropriate combination can be selected and route guidance can be performed, enabling the user to optimally set the waypoints of the shops.

The search method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be distributed through a network such as the Internet.

1-15. (canceled)

16. A search apparatus comprising:
an input unit that receives an input of search-object information indicative of facilities to be searched for;
a designating unit that designates, among combinations of facilities indicated by the search-object information, a combination of the facilities that are located on the same premises;
a generating unit that, using location information concerning the facilities constituting the combination designated by the designating unit, generates search result information; and
an output unit that outputs the search result information generated by the generating unit.

17. The search apparatus according to claim 16 further comprising:
an extracting unit that extracts, from map information depicting an arbitrary search area on a map, the location information concerning the facilities indicated by the search-object information received by the input unit;
a calculating unit that, using the location information extracted by the extracting unit, calculates one or more inter-facility distances between the facilities indicated by the search-object information, wherein
the designating unit designates, among the combinations of the facilities indicated by the search-object information and having inter-facility distances at or below a threshold, the combination of facilities that are located on the same premises.

18. A search apparatus comprising:
a storage unit that stores information concerning complex facilities that each have a plurality of facilities;
an input unit that receives an input of search-object information indicative of facilities to be searched for; and
a searching unit that, based on the information concerning complex facilities, searches for a complex facility having the facilities that are indicated by the search-object information.

19. A search method comprising:
receiving an input of search-object information indicative of facilities to be searched for;
designating, among combinations of facilities indicated by the search-object information, a combination of the facilities that are located on the same premises;
generating, using location information concerning the facilities constituting the combination designated at the designating, search result information; and
outputting the search result information generated at the generating.
